(19) United States
(12) Patent Application Publication
(10) Pub. No.: US 2013/0165133 A1
(43) Pub. Date: Jun. 27, 2013

(54) METHOD, CONTROLLER NODE, COMPUTER PROGRAM AND COMPUTER PROGRAM PRODUCT FOR RELEASING RESOURCES

(71) Applicant: Telefonaktiebolaget L M Ericsson (publ), Stockholm (SE)

(72) Inventors: Tomas Georg LAGERQVIST, Stockholm (SE); Malin Ljungberg, Uppsala (SE)

(73) Assignee: Telefonaktiebolaget L M Ericsson (publ), stockholm (SE)

(21) Appl. No.: 13/716,888

(22) Filed: Dec. 17, 2012

(30) Foreign Application Priority Data
Dec. 21, 2011 (EP) 11194943.4

(51) Int. Cl. H04W 72/04

(52) U.S. Cl. CPC H04W 72/0486
USPC 455/450

(57) ABSTRACT

It is presented a method, performed in a controller node being responsible for resource utilisation for at least part of a mobile communication network. The method comprises the steps of: obtaining a utilisation value, being a value of resource utilisation in the controller node; determining a release rate value and an inactivity timer value based on the utilisation value; and releasing resources having been assigned by the controller node for communication with at least one mobile terminal, and having been inactive for a period longer than the inactivity timer value, the resources being released at a rate being less than or equal to the release rate value. A corresponding controller node, computer program and computer program product are also presented.

### CROSS REFERENCE TO RELATED APPLICATION

The present application claims priority to European Patent Application No. 11194943.4, filed Dec. 21, 2011, the disclosure of which is hereby incorporated herein by reference as if set forth fully herein.

### TECHNICAL FIELD

The invention relates to a controller node in a mobile communication network. In particular the invention relates to how resources are released from the controller node.

### BACKGROUND

Congestion in LTE (Long Term Evolution) can be a real issue. When congestion occurs, e.g. as measured by the number of used resources in an e-Node B (evolved Node B), this can e.g. be defined as a hard limit of utilisation, above which utilisation is not allowed (or able) to pass.

This creates a situation where a lot of resources, on occasion, need to be released more or less instantaneously, which in itself can create congestion due to high demands on hardware and/or radio resources for control messages. Moreover, some of the released resources will try and may be allowed to reconnect again, whereby the release and reattach occur for no reason in these cases.

It would be desirable if congestion issues in the e-Node B can be handled in such a way that sub-optimisation when resources have to be released is avoided or at least reduced.

### SUMMARY

It is an object of at least some embodiments herein to eliminate or at least alleviate the problem discussed above.

In a first aspect, it is presented a method, performed in a controller node being responsible for resource utilisation for at least part of a mobile communication network. The method comprises the steps of: obtaining a utilisation value, being a value of resource utilisation in the controller node; determining a release rate value and an inactivity timer value based on the utilisation value; and releasing resources having been assigned by the controller node for communication with at least one mobile terminal, and having been inactive for a period longer than the inactivity timer value, the resources being released at a rate being less than or equal to the release rate value.

Using the inactivity timer value combined with the release rate, a more gradual release of resources is achieved, compared to what is known in the art. This reduces the risk of utilisation quickly reaching or exceeding the maximum allowable utilisation, and this thus prevents chaotic and suboptimal release of resources.

In the step of determining, a smaller inactivity timer value may be determined for a higher utilisation value. In other words, when utilisation is higher, inactive resources can be released quicker.

In the step of determining, a greater release rate value may be determined for a higher utilisation value. In other words, when utilisation is higher, resources can be released at a faster rate. The step of determining may involve comparing the utilisation value to a threshold value.

The step of determining may involve the use of a plurality of threshold values for a respective plurality of utilisation values. More threshold values provide finer control in the balance of releasing resources immaturely and being active when utilisation is getting high.

The step of determining may comprise the use of an algebraic function defining the inactivity timer value depending on the utilisation value and an algebraic function defining the release rate value depending on the utilisation value.

The controller node may be an evolved Node B and the utilisation value may be a number of established radio bearers of the evolved Node B. In other words, it can be the number of established radio bearers which indicates the utilisation.

The utilisation value may be a number of mobile terminals having radio bearers set up with the controller node. In other words, it can be the number of established mobile terminals which indicates the utilisation.

In the step of releasing a resource, the resource may be an established radio bearer of the controller node. Optionally, the method only releases radio sources on a radio bearer granularity.

In the step of releasing a resource, resources may be released which are radio bearers associated with a mobile terminal having radio bearers set up with the controller node. In this way, resources are released on a mobile terminal granularity.

The step of releasing a resource may use a priority indicator when determining the order in which resources are released.

The priority indicator may be a flag indicating that the resource is vulnerable for pre-emption. This is a flag which is available according to the set of LTE standards.

The inactivity timer value may be set to be infinity when the utilisation level is low. In other words, at low utilisation level, no resources are released as part of this method.

A second aspect is a controller node arranged to be responsible for resource utilisation for at least part of a mobile communication network. The controller node comprises: a resource manager arranged to obtain a utilisation value, being a value of resource utilisation in the controller node; a processor arranged to determine a release rate value and an inactivity timer value based on the utilisation value. The resource manager is arranged to release resources having been connected to the controller node and having been inactive for a period longer than the inactivity timer value, the resources being released at a rate being less than or equal to the release rate value.

The controller node may be comprised in an evolved node B node of a Long Term Evolution mobile communication network.

A third aspect is a computer program for a controller node being responsible for resource utilisation for at least part of a mobile communication network. The computer program comprises computer program code which, when run on the controller node, causes the controller node to: obtain a utilisation value, being a value of resource utilisation in the controller node; determine a release rate value and an inactivity timer value based on the utilisation value; and release resources having been assigned by the controller node for communication with at least one mobile terminal, and having been inactive for a period longer than the inactivity timer value, the resources being released at a rate being less than or equal to the release rate value.

A fourth aspect is a computer program product comprising a computer program according to the third aspect and a non-transitory computer readable media on which the computer program is stored.

It is to be noted that any feature of any aspect may, where appropriate, be applied to any other aspects.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the invention are now described, by way of example, with reference to the accompanying drawings, in which:

FIG. 1 is a schematic diagram illustrating an environment where embodiments presented herein can be applied;

FIG. 2 is a schematic histogram illustrating how various levels of resource utilisation affect resource usage in the controller node of FIG. 1;

FIG. 3 is a flow chart illustrating a method according to one embodiment, performed in the controller node of FIG. 1;

FIG. 4 is a schematic diagram showing some components of the controller node of FIG. 1; and

FIG. 5 shows one example of a computer program product comprising a non-transitory computer readable media.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

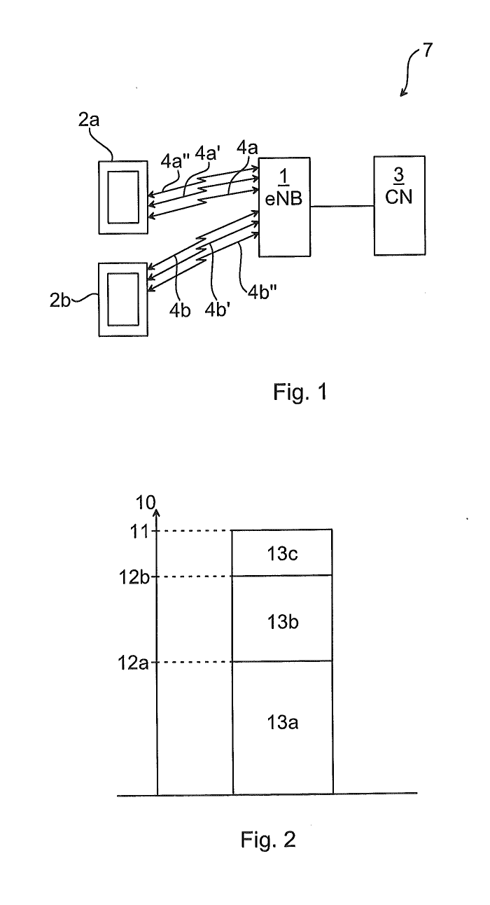

FIG. 1 is a schematic diagram illustrating a mobile communication network 1 where embodiments presented herein can be applied. The mobile communications network 1 comprises a core network 3 and one or more controller nodes 1 in the form of evolved Node Bs 1, also known as e-Node Bs or eNBs. The controller nodes 1 provide radio connectivity to a plurality of mobile terminals 2a-b. The term mobile terminal is also known as user equipment, mobile communication terminal, user terminal, user agent, etc.

The mobile communication network, can e.g. comply with LTE (Long Term Evolution) or with any one or a combination of UMTS (Universal Mobile Telecommunications System), CDMA2000 (Code Division Multiple Access 2000), etc.

The communication between the first mobile terminal 2a and the controller node 1 occurs over one ore more radio bearers 4a, 4a′, 4a″. Analogously, the communication between the second mobile terminal 2b and the controller node 1 occurs over one or more radio bearers 4b, 4b′, 4b″. Each mobile terminal in LTE needs to allocate a minimum of two radio bearers comprising one signaling radio bearers and one default radio bearer. Optionally, more radio bearers can be set up for each mobile terminal. In the example of FIG. 1, three radio bearers are shown for between the respective mobile terminals 2a-b and the controller node 1.

FIG. 2 is a schematic histogram illustrating how various levels of resource utilisation affect resource usage in the controller node of FIG. 1. The vertical axis indicates utilisation value 10. The utilisation value 10 can e.g. be the number of established radio bearers in the controller node or the number of mobile terminals having radio bearers set up with the controller node. There is a maximum limit 11 (also known as hard limit, although this can be configurable) of how high the utilisation is allowed to go. One concept of embodiments presented herein will now be described, where the controller node goes into congestion handling at a level lower than the maximum limit 11. This is done by introducing a congestion threshold, which is lower than the hard limit, and to start releasing inactive pre-emptable resources when this limit is reached.

According to the ideas presented herein, there is thus also a lower threshold value 12a and a higher threshold value 12b. This creates three zones 13a-c of utilisation: a low utilisation zone 13a, a medium utilisation zone 13b and a high utilisation zone.

Depending on the level of utilisation, as indicated by which one of the zones 13a-c, a release rate value and an inactivity timer value are determined. The inactivity timer indicates how long a resource can be inactive until it is released and the release rate indicates the maximum rate at which resources are allowed to be released. By using the release rate, the bursty behaviour of the conventional radio bearer pre-emption mechanism is reduced through the flow control of the release rate use. The flow control of the release rate can be implemented with a mechanism ensuring that, after a resource has been pre-empted, the process waits certain amount of time before another resource is considered for pre-emption. The release rate value and inactivity timer value can be configured independently for the three zones to achieve desired congestion handling.

The general idea is that for utilisation values in the low zone 13a, utilisation is low and unused resources can remain established to reduce set-up time when the resource needs to be used again.

For utilisation values in the medium zone 13b, utilisation is somewhat higher, and for example the inactivity timer can be set to a lower value, whereby inactive resources are released sooner.

For utilisation values in the high zone 13c, utilisation is high, whereby can be set the inactivity timer to an even lower value and the release rate can be set higher, allowing resources to be released quickly to avoid reaching the maximum limit 11.

An advantage of the presented embodiment is that more resources can be considered for pre-emption (release) as the utilisation value approaches the maximum limit 11. This allows for a more precise calibration of the workings of the early congestion threshold algorithm to a specific overload traffic pattern.

While FIG. 2 shows an example with three zones, the concepts presented herein are equally applicable to other number of zones, including two, four, five, etc.

Alternatively, the zones 13a-c can be replaced with two algebraic functions defining the release rate and inactivity timer values as a function of the utilisation value, respectively.

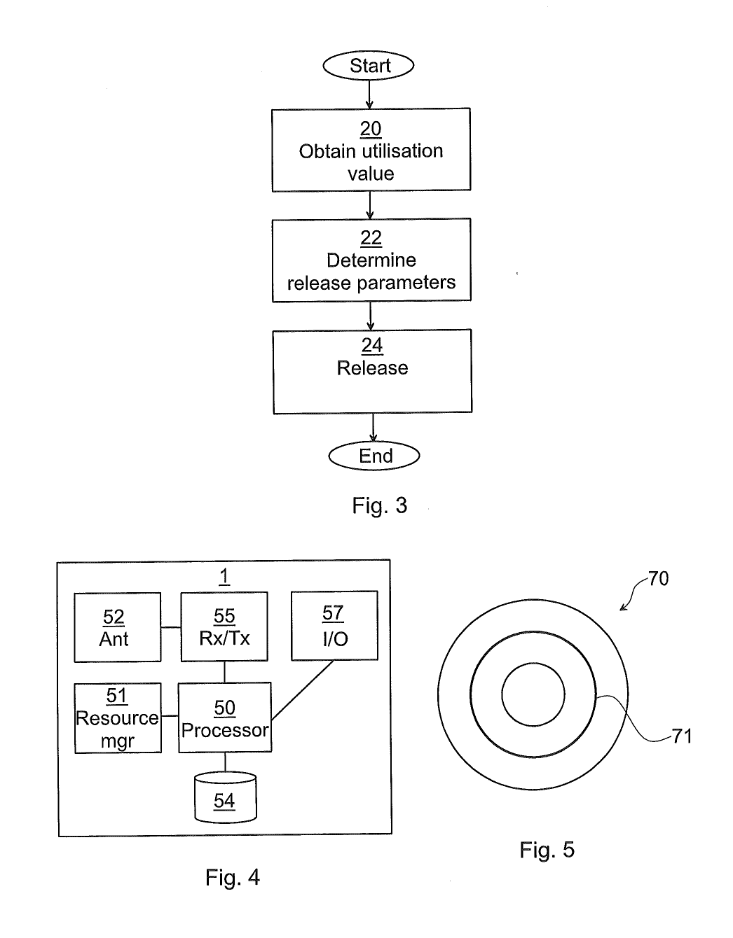

FIG. 3 is a flow chart illustrating a method according to one embodiment, performed in the controller node of FIG. 1. In many ways, the method works as described above with reference to FIG. 2.

In an obtain utilisation value step 20, a utilisation value is obtained, where the utilisation value is a value of resource utilisation in the controller node. In one embodiment, the controller node is an evolved Node B and the utilisation value reflects the number of established radio bearers of the evolved Node B. In one embodiment, the utilisation value is a number of mobile terminals having radio bearers set up with the controller node.

In a determine release parameters step 22, the release rate value and the inactivity timer value are determined based on the utilisation value. A higher utilisation value can result in a smaller inactivity timer value, leading to a quicker action to release unused resources. A higher utilisation value can also result in a greater release rate. In other words, a higher utilisation can result in actions to release resources faster. In one embodiment, the inactivity timer value is set to infinity when the utilisation level is low, whereby no resources are released in such a situation.

The determining can involve the use of one or more threshold values as explained with reference to FIG. 2 above. Alternatively, an algebraic function can be used to define the release rate value and/or inactivity timer value. In this way, a predefined analytic function can be used for this determining.

In a release step 24, resources having been assigned by the controller node for communication with at least one mobile terminal are released. These resources are released when they have been inactive for a period longer than the inactivity timer value, at a rate being less than or equal to the release rate value. In other words, the release rate value is not exceeded.

Each one of the resources that are released can for example be an established radio bearer of the controller node. Alternatively, each one of the resources that are released can be radio bearers associated with a mobile terminal having radio bearers set up with the controller node.

It is to be noted that the type of resources that are released can, but does not need to, differ from the source of the utilisation value. In other words, a utilisation value can be the number of established radio bearers while the resources being released can be at the granularity of all radio bearers for a mobile terminal. Alternatively, the utilisation value can be the number of mobile terminals having radio bearers set up with the controller node while the resources being released can be individual radio bearers.

Optionally, a priority indicator can be used to determine the order in which resources are released. For example, the priority indicator can be a flag indicating that the resource is vulnerable for pre-emption, such that resources that are indicated to be vulnerable for pre-emption are released first, as defined in the 3GPP standard (TS 23.401, Section 4.7.3)

FIG. 4 is a schematic diagram showing some components of the controller node 1 of FIG. 1. A processor 50 is provided using any suitable central processing unit (CPU), multiprocessor, pool of processors, microcontroller, digital signal processor (DSP), application specific integrated circuit etc., capable of executing software instructions stored in a computer program product 54, e.g. in the form of a memory. The computer program product 54 can be a memory or any combination of read and write memory (RAM) and read only memory (ROM). The memory also comprises persistent storage, which, for example, can be any single one or combination of magnetic memory, optical memory, solid state memory or even remotely mounted memory.

The controller node 1 also comprises an I/O interface 57 for communicating with the core network and optionally with other controller nodes.

The controller node 1 also comprises one or more transceivers 55, comprising analogue and digital components, and a corresponding number of antennas 52 for radio communication with mobile terminals.

A resource manager 51 is also part of the controller node 1. The resource manager 51 is arranged to obtain a utilisation value in accordance with what is described above with reference to the flow chart of FIG. 3. The resource manager 51 is a module which can be implemented using hardware and/or software, such as a computer program executed by the processor 50.

Other components of the controller node are omitted in order not to obscure the concepts presented herein.

FIG. 5 shows one example of a computer program product 70 comprising a non-transitory computer readable media. On this non-transitory computer readable media, a computer program 71 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied as a memory circuit of a device, such as the computer program product 54 of FIG. 4. While the computer program 71 is here schematically shown as a track on the depicted optical disk, the computer program can be stored in any way which is suitable for the computer program product.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method, performed by a controller node responsible for resource utilisation for at least part of a mobile communication network, the method comprising the steps of:
obtaining a utilisation value indicating resource utilisation in the controller node;
determining a release rate value and an inactivity timer value based on the utilisation value; and
releasing resources having been assigned by the controller node for communication with at least one mobile terminal, and having been inactive for a period longer than the inactivity timer value, the resources being released at a rate being less than or equal to the release rate value.

2. The method according to claim 1, wherein in the step of determining, a smaller inactivity timer value is determined in response to a higher utilisation value.

3. The method according to claim 1, wherein in the step of determining, a greater release rate value is determined in response to a higher utilisation value.

4. The method according to claim 1, wherein the step of determining comprises comparing the utilisation value to a threshold value.

5. The method according to claim 1, wherein the step of determining comprises comparing a plurality of the utilisation values to a respective plurality of threshold values.

6. The method according to claim 1, wherein the step of determining comprises using an algebraic function to determine the inactivity timer value in response to the utilisation value, and using an algebraic function to determine the release rate value in response to the utilisation value.

7. The method according to claim 1, wherein the controller node is an evolved Node B and the utilisation value is a number of established radio bearers of the evolved Node B.

8. The method according to claim 1, wherein the utilisation value is a number of mobile terminals having radio bearers set up with the controller node.

9. The method according to claim 1, wherein in the step of releasing a resource, the resource is an established radio bearer of the controller node.

10. The method according to claim 1, wherein in the step of releasing a resource, resources are released which are radio bearers associated with a mobile terminal having radio bearers set up with the controller node.

11. The method according to claim 1, wherein the step of releasing a resource comprises using a priority indicator to determine an order with which resources are to be released.

12. The method according to claim 11, wherein the priority indicator is a flag indicating that the resource is vulnerable for pre-emption.

13. The method according to claim 1, wherein the inactivity timer value is set to be infinity when the utilisation level is low.

14. A controller node arranged to be responsible for resource utilisation for at least part of a mobile communication network, the controller node comprising:
a resource manager arranged to obtain a utilisation value indicating resource utilisation in the controller node;
a processor arranged to determine a release rate value and an inactivity timer value based on the utilisation value; and
wherein the resource manager is arranged to release resources having been connected to the controller node and having been inactive for a period longer than the inactivity timer value, the resources being released at a rate being less than or equal to the release rate value.

15. The controller node according to claim 14, wherein the controller node is comprised in an evolved node B node of a Long Term Evolution mobile communication network.

16. A computer program for a controller node responsible for resource utilisation for at least part of a mobile communication network, the computer program comprising computer program code which, when executed by the controller node, causes the controller node to:
obtain a utilisation value indicating resource utilisation in the controller node;
determine a release rate value and an inactivity timer value based on the utilisation value; and
release resources having been assigned by the controller node for communication with at least one mobile terminal, and having been inactive for a period longer than the inactivity timer value, the resources being released at a rate being less than or equal to the release rate value.

17. A computer program product comprising a computer program according to claim 16 and a non-transitory computer readable media on which the computer program is stored.
